(19) United States
(12) Patent Application Publication
(10) Pub. No.: US 2023/0330449 A1
(43) Pub. Date: Oct. 19, 2023

(54) RESPIRATORY MASK ASSEMBLY

(71) Applicant: Active Mask Pty. Ltd., Collingwood (AU)

(72) Inventors: Adrian CRITCHLOW, Albert Park (AU); Mehdi QERIM, Fitzroy (AU)

(73) Assignee: ACTIVE MASK PTY LTD, Collingwood (AU)

(21) Appl. No.: 18/245,621

(22) PCT Filed: Sep. 16, 2021
(86) PCT No.: PCT/AU2021/051072

§ 371 Date: Mar. 16, 2023

(30) Foreign Application Priority Data
Sep. 16, 2020 (AU) 2020102286

(51) Int. Cl. A62B 18/08; A62B 23/02; A41D 13/11

(52) U.S. Cl. CPC A62B 18/08; A62B 23/02; A41D 13/11

(57) ABSTRACT

A respiratory mask assembly (1000, 1000′) concerns a respiratory mask of the half-face type that covers the nose and mouth of a wearer, having modular construction permitting ready assembly and disassembly, and interchangeability of components, and in particular a mask cover (100) and a face shield (700). A mask cover (100) or face shield (700) is removably fitted to a preferably transparent facepiece (500) on its outwardly-facing side, and a mask stiffener (600) removably fitted to an opposing inwardly-facing side of the facepiece (500). Filter assemblies (300) position and claim these components (100 or 700, 500, 600) together. An exhaust assembly (400) provides an exhalation port from the facepiece (500) and is preferably occluded by the mask cover (100) or face shield (700).

### TECHNICAL FIELD

The present invention concerns respiratory masks.

### BACKGROUND ART

Respiratory masks are also termed respirators, or respirator masks, and these terms are used interchangeably herein except where context indicates otherwise. Many designs and configurations for respirators exist, and are adapted for specific applications. Respirators provide filtration of inhaled air for particulate and/or gases and vapours, according to the type and grade of filtration used.

Various fields, such as the medical, agricultural, construction, military and domestic sectors have specific applications for respirators. The objective of respiratory masks is to limit exposure to irritants, toxins or contaminants, and the level of performance offered by a particular configuration may be characterised by a numerical ASF (assigned protection factor).

COVID-19 (novel coronavirus of 2019) has prompted a surge of interest and demand in PPE (personal protective equipment) for limiting viral contagion across business and government organisations, as well as the broader population. Wearing of face masks has been encouraged or mandated, with 3-ply disposable face masks deemed compliant in many instances. The efficacy of such face masks is not conclusive however, despite widespread use.

Respirators are accepted as providing a generally higher level of protection from airborne contaminants of many kinds when compared to, for example, 3-ply disposable face masks. Respirators on account of various limitations (some of which are described here) are not universally suited to general use, and in many instances, are not even particularly well suited for use beyond their specialised application.

Limitations of existing styles and technical designs of respirators include but are not limited to the fact that they are often relatively bulky in form, often visually obtrusive, and do not lend themselves well to being cleaned or sterilised.

An objective of the present invention is to at least attempt to address one or more of these and other limitations of existing respirators.

### SUMMARY OF INVENTION

A respiratory mask assembly according to the present invention in particular concerns a respiratory mask of the half-face type that covers the nose and mouth, in distinction to a full-face type mask which seals around the entire facial area. A respiratory mask assembly of the present invention is of modular construction permitting ready assembly and disassembly, and interchangeability of components, and in particular a mask cover and a face shield as described herein in preferred embodiments.

A mask stiffener is removably fitted to the facepiece on its inwardly-facing side, and the mask cover is removably fitted to the facepiece on its outwardly-facing side by attachment to the mask stiffener, and preferably may be interchanged with a face shield as required.

A filter assembly and preferably a pair of filter assemblies provide inhalation ports through the facepiece and the mask stiffener, and preferably also the mask cover or face shield. An exhaust assembly is fitted to provide an exhalation port though the facepiece.

The respiratory mask assembly preferably further comprises head straps that position the assembly to the wearer's face in use, with the facepiece sealing around the nose and mouth when worn.

A respiratory mask assembly of the described type has mask covers that are interchangeable. This permits a specific indicia or design to be applied to the mask cover. A mask cover of different design may be substituted as required, or the mask cover replaced in the event of wear or damage.

The facepiece is preferably transparent or translucent, and these terms are used interchangeably. A particular benefit of transparency is that the facepiece is susceptible to UV (ultraviolet) light sterilisation procedures. Opposing surfaces of the facepiece can be sterilised with UV light simultaneously on account of UV light passing through the transparent material of the facepiece. Moreover, any particular bulk contaminant or mark on the surface of the facepiece should also by virtue of its transparency be all the more readily discerned from visual inspection. A further benefit of a facepiece being transparent is that it reveals a greater portion of the wearer's face.

A face shield is configured to be removably fitted to the respiratory mask assembly as required. The face shield is removably fitted as a substitute for the mask cover when required, and extends upwards to just above the eyes to terminate at the forehead of the wearer. The face shield is spaced apart from the face by spacers extending from an inwardly-facing side of the face shield, which may rest or occasionally contact the wearer's face between the forehead and temples.

The exhaust assembly of the respiratory mask assembly described herein is occluded from view by the mask cover or the face shield.

The respiratory mask assembly abovementioned shares a common construction as described and depicted below in connection with a preferred form of the present invention.

### BRIEF DESCRIPTION OF THE DRAWINGS

FIG. 1A and FIG. 1B depict front and rear perspective views respectively of a respiratory mask assembly in one configuration of a preferred embodiment of the present invention.

FIG. 2 depicts an exploded view of the respiratory mask assembly as configured in FIG. 1A and FIG. 1B.

FIG. 3A and FIG. 3B depict front and rear views respectively of the respiratory mask assembly of FIG. 1A and FIG. 1B.

FIG. 4A and FIG. 4B depict a top and bottom views respectively of the respiratory mask assembly as configured in FIG. 1A and FIG. 1B.

FIG. 5A and FIG. 5B depict side views of the respiratory mask assembly as configured in FIG. 1A and FIG. 1B.

FIG. 6A and FIG. 6B depict front and rear perspective views respectively of a filter assembly forming a component of the respiratory mask assembly of FIG. 1A and FIG. 1B.

FIG. 7 depicts an exploded view of the filter assembly of FIG. 6A and FIG. 6B.

FIG. 8A and FIG. 8B depict front and rear views respectively of the filter assembly of FIG. 6A and FIG. 6B.

FIG. 9 depicts a side view of the filter assembly of FIG. 6A and FIG. 6B.

FIG. 10A and FIG. 10B depict front and rear perspective views respectively of an exhaust assembly forming part of the respiratory mask assembly of FIG. 1A and FIG. 1B.

FIG. 11 depicts an exploded view of the exhaust assembly of FIG. 10A and FIG. 10B.

FIG. 12A and FIG. 12B depict front and rear views respectively of the exhaust assembly of FIG. 10A and FIG. 10B.

FIG. 13A and FIG. 13B depict top and bottom views respectively of the exhaust assembly of FIG. 10A and FIG. 10B.

FIG. 14 depicts a side view of the exhaust assembly of FIG. 10A and FIG. 10B.

FIG. 15A and FIG. 15B depict front and rear perspective views respectively of the respiratory mask assembly of FIG. 1A and FIG. 1B in another configuration in which a mask cover is interchanged for a face shield.

FIG. 16 depicts an exploded view of the respiratory mask assembly as configured in FIG. 15A and FIG. 15B.

FIG. 17A and FIG. 17B depict front and rear views respectively of the respiratory mask assembly as configured in FIG. 15A and FIG. 15B.

FIG. 18A and FIG. 18B depict top and bottom views respectively of the respiratory mask assembly as configured in FIG. 15A and FIG. 15B.

FIG. 18B illustrates an aspect of the subject matter in accordance with one embodiment.

FIG. 19A and FIG. 19B depict side views of the respiratory mask assembly as configured in FIG. 15A and FIG. 15B.

### DETAILED DESCRIPTION OF PREFERRED EMBODIMENTS

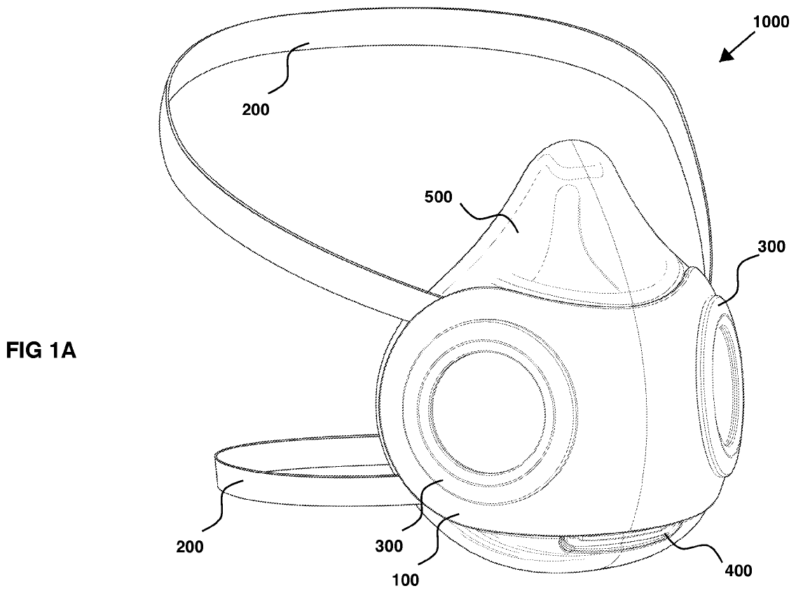

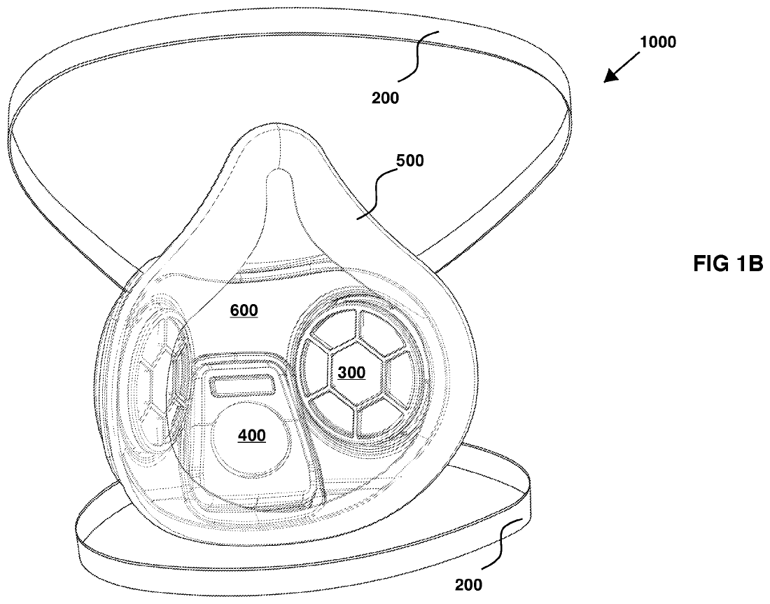

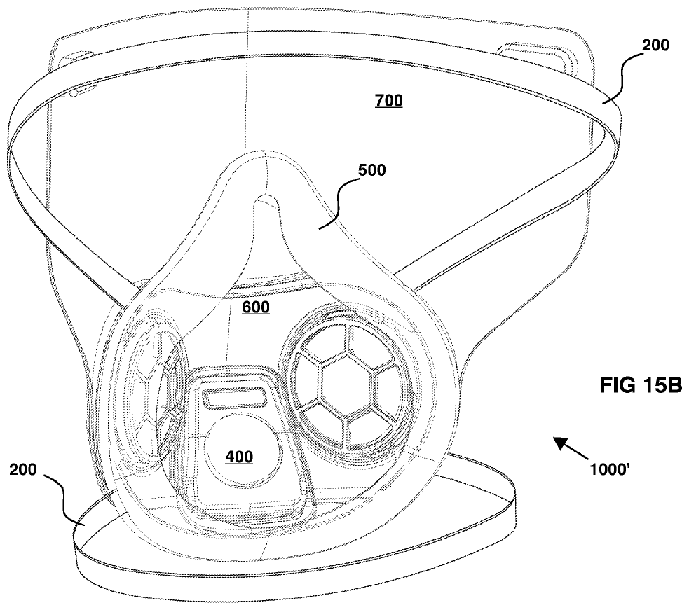

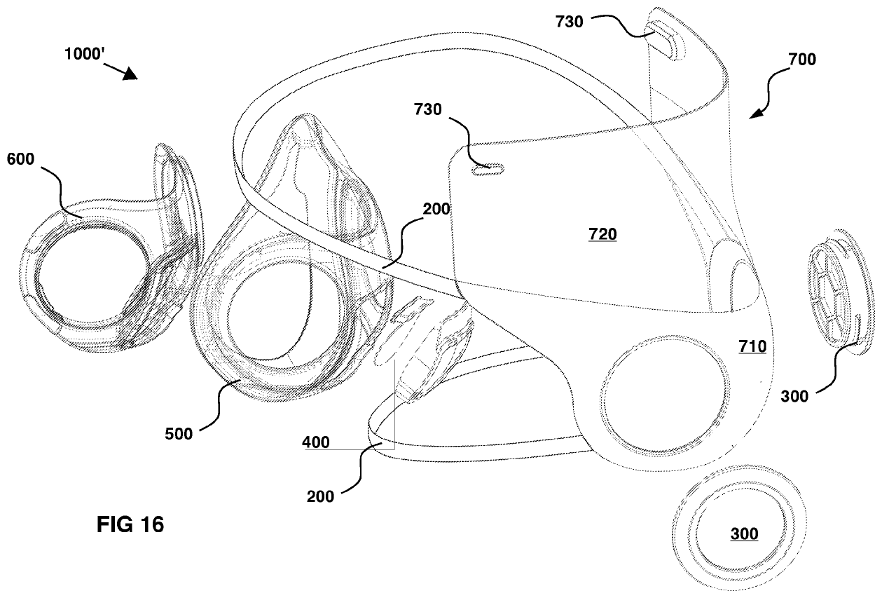

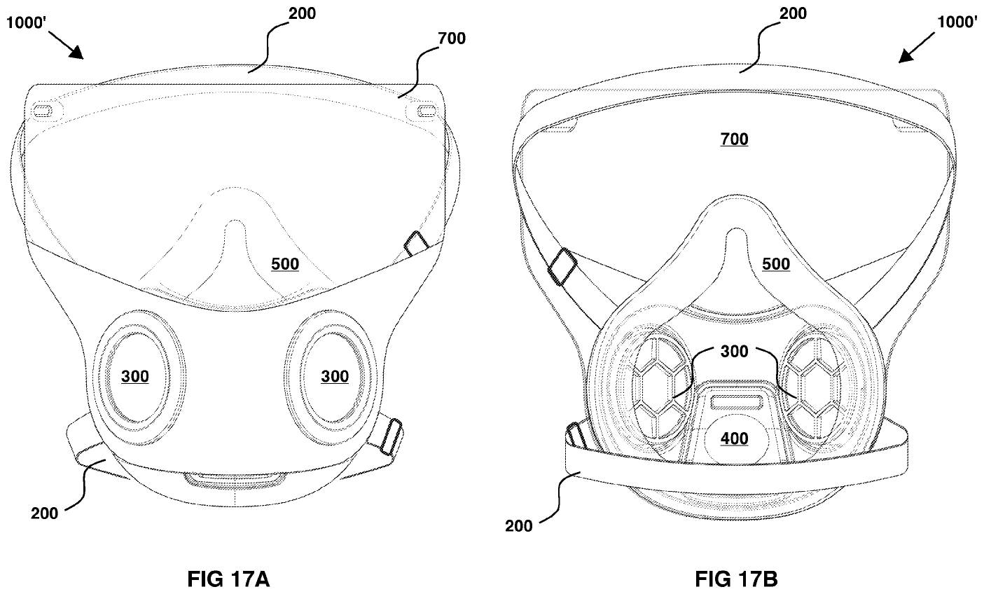

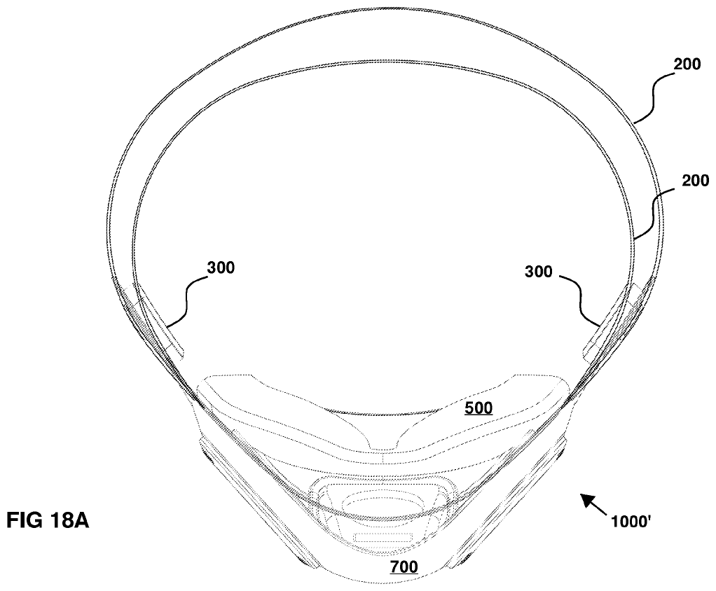

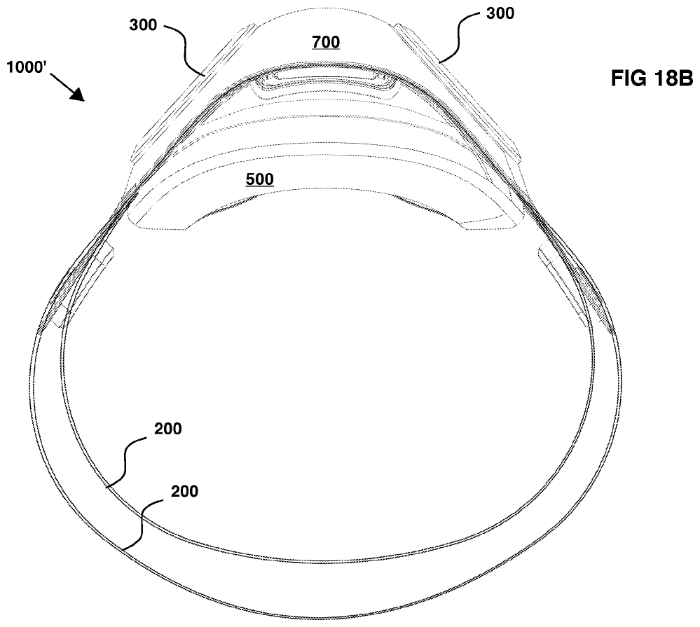

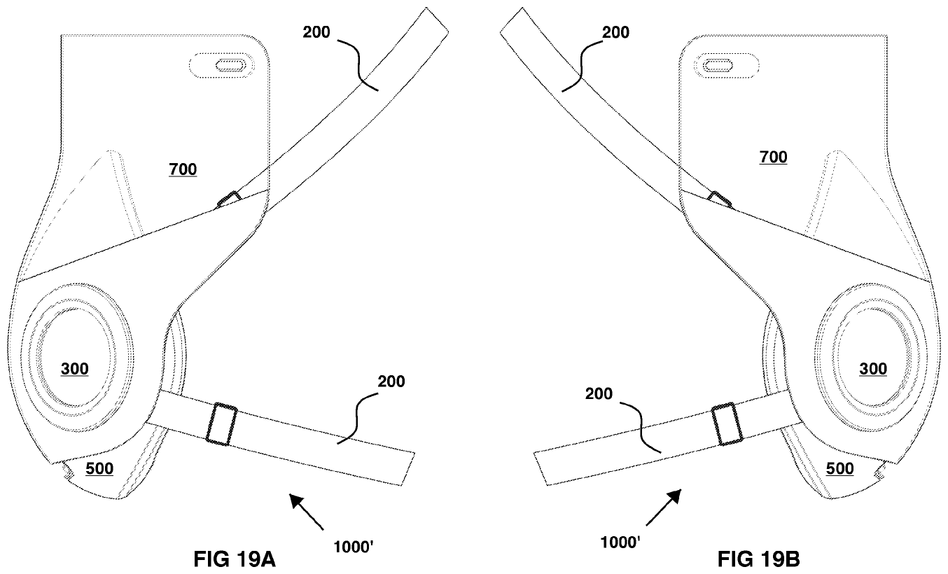

The accompanying drawings depict a respirator mask assembly 1000, 1000′ according to a preferred embodiment of the present invention, which can be configured with either a mask cover 100 (FIG. 1A and FIG. 1B) or a face shield 700 (FIG. 15A and FIG. 15B) as further described below in connection with the accompanying drawings.

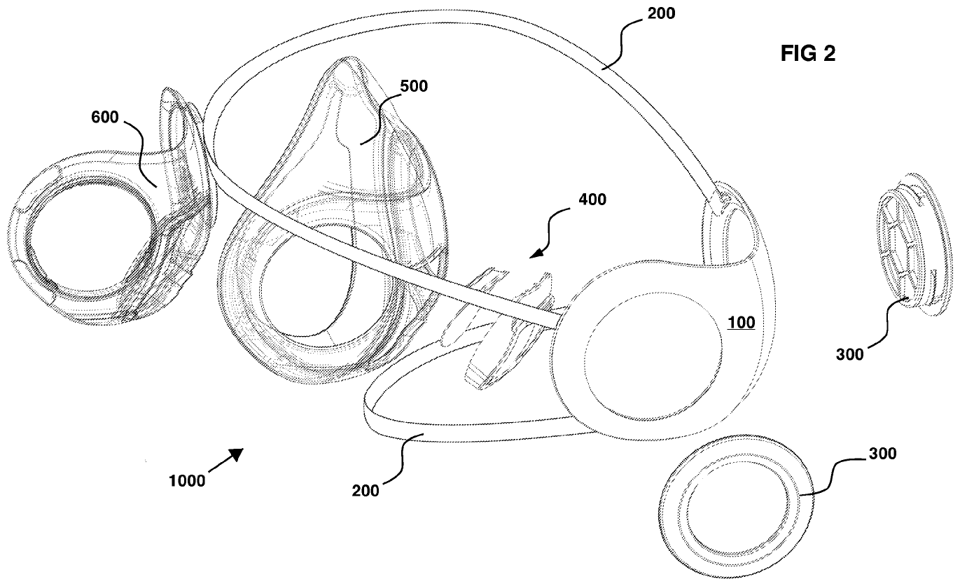

FIG. 2 depicts components of the respiratory mask assembly 1000 in exploded view. As noted, this configuration of the respiratory mask assembly 1000 includes a mask cover 100.

The mask cover 100 is preferably of a fabric material, and preferably a hard-wearing fabric such as ballistic nylon, though may acceptable substitutes are possible, as will be appreciated.

Head straps 200 are removably fitted to the mask cover 100. The head straps 200 are made of an elastomeric material, and looped so that their linear length may be adjusted by a wearer (not shown) for comfort and fit using adjustable buckles positioned along their length. Other configurations of straps or alternatives for fitting the assembly are possible, as will be appreciated.

The mask cover 100 is removably fitted to a facepiece 500, on its outwardly-facing side of a facepiece 500. The facepiece 500 is sealable against the wearer's face, around the nasal region and oral region of a wearer's face. The facepiece 500 is shaped and configured to conform readily to this region of the face and moreover to accommodate individual variances in facial topology. The facepiece 500 is formed from medical-grade silicone (or a suitable substitute). The sealing edge of the facepiece 500 is sufficiently pliable in the manner configured (as depicted, with a rolled peripheral lip) to readily conform under mild pressure from the head straps 200.

Mask stiffener 600 is removably fitted to the facepiece 500 at an opposing side of the facepiece 500 to the mask cover 100, namely an inwardly-facing side of the facepiece 500.

The relative terms outwardly-facing side and inwardly-facing side characterise the opposing sides of the facepiece 500, and are used in connection with the mask cover 100 (removably fitted to outwardly-facing side) and mask stiffener 600 (removably fitted to inwardly-facing side). Relative positional or orientational terms such as upper and lower or top and bottom reference the usual position of the assembly 1000 and its components when worn with the wearer standing upright.

Two filter assemblies 300 are positioned as indicated in the assembly 1000, and described in further detail below. The filter assemblies 300 provide respective inhalation ports through which a wearer of the assembly 1000 may inhale. The filter assemblies 300 are configured to span or pass through the mask cover 100, the facepiece 500, and the mask stiffener 600, and thus provide incoming passage of filtered air through these components 100, 500, 600 to the wearer of the assembly 1000. The filter assemblies 300 removably attach to the mask stiffener 600, and thus assist in clamping together the mask cover 100, the facepiece 500 and the mask stiffener 600, as well as securely positioning the filter assemblies 300 relative to the facepiece 500. The filter assemblies 300 removably attach to the mask stiffener 600 by threaded engagement by way of co-operating features on these respective pieces. Other means of attachment may be used, as will be appreciated.

An exhaust assembly 400 is positioned as indicated in the assembly 1000, and also described in further detail below. The exhaust assembly 400 provides an exhaust port through which the wearer of the assembly 1000 may exhale (but not inhale). The exhaust assembly 400 is configured to span or pass through the facepiece 500, and additionally the mask stiffener 600 in the preferred embodiment. The exhaust assembly 400 does not pass through the mask cover 100 in the embodiment depicted and described herein. Rather, the mask cover 100 occludes the exhaust assembly 400 from view, at least in part. A small portion of the exhaust assembly 400 may be visible, as is evident from the preferred embodiment depicted. Exhaled breath from the wearer is discharged from the exhaust assembly 400 below the mask cover 100.

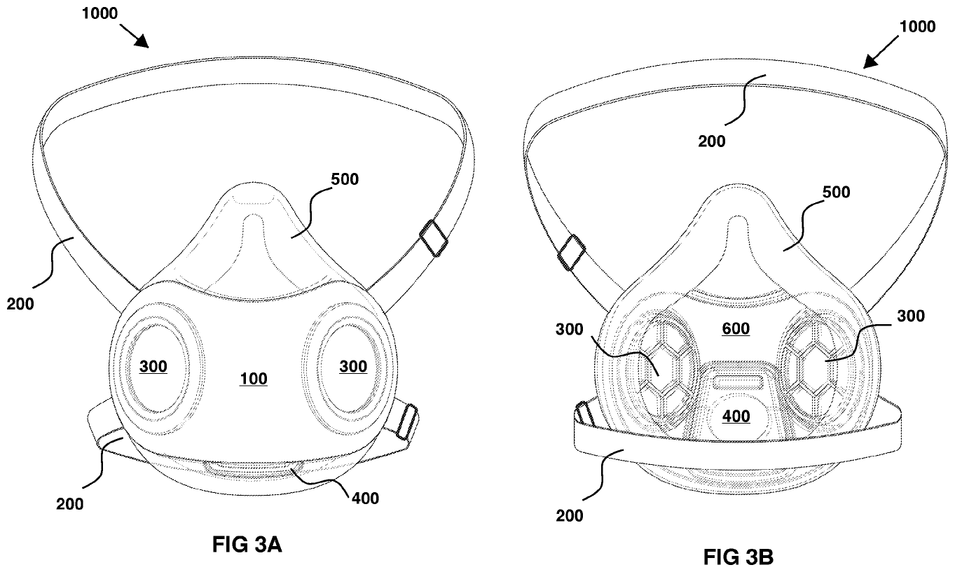

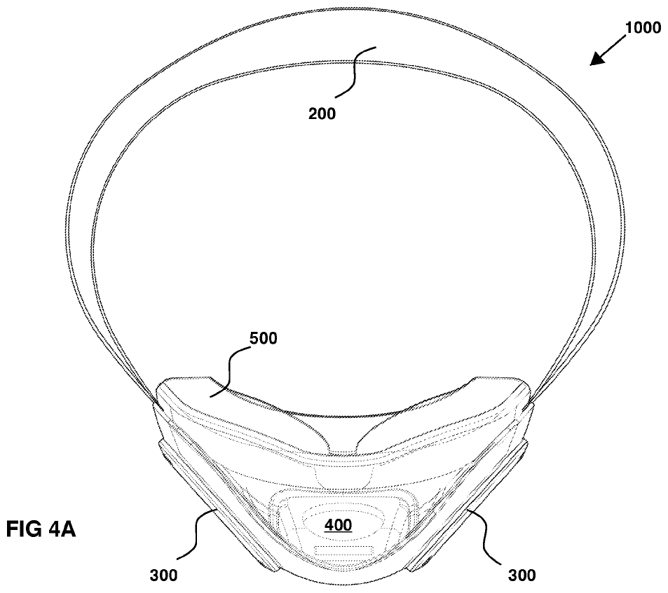

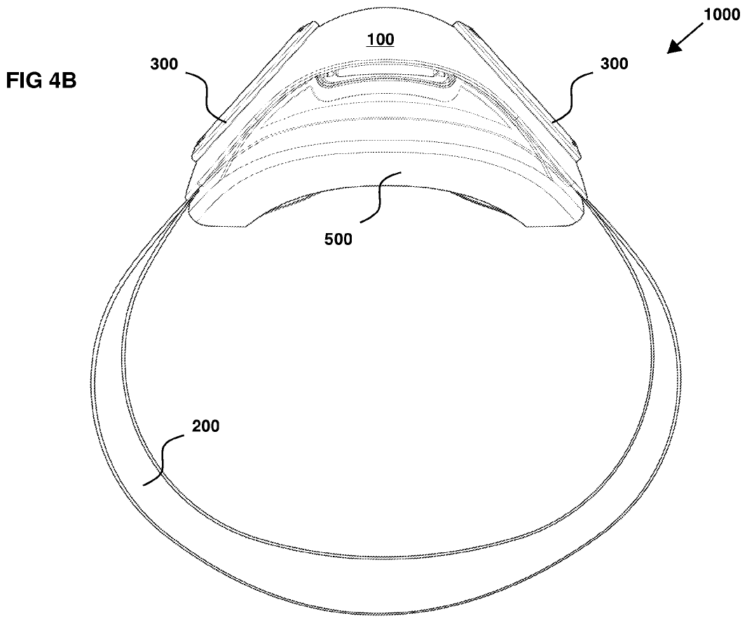

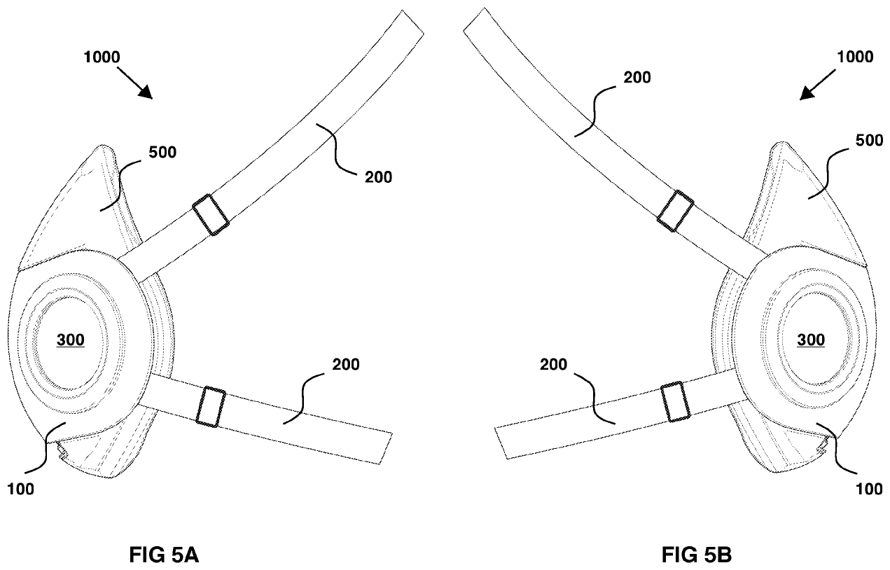

FIG. 3A and FIG. 3B depict front and rear views of the assembly 1000 similar to FIG. 1A and FIG. 1B. Adjustable buckles 210 are depicted forming part of the head straps 200, as described above. FIG. 4A and FIG. 4B depict top and bottom views (that is, in plan) of the assembly 1000, and are included for completeness. Similarly, FIG. 5A and FIG. 5B depict side views (that is, in elevation).

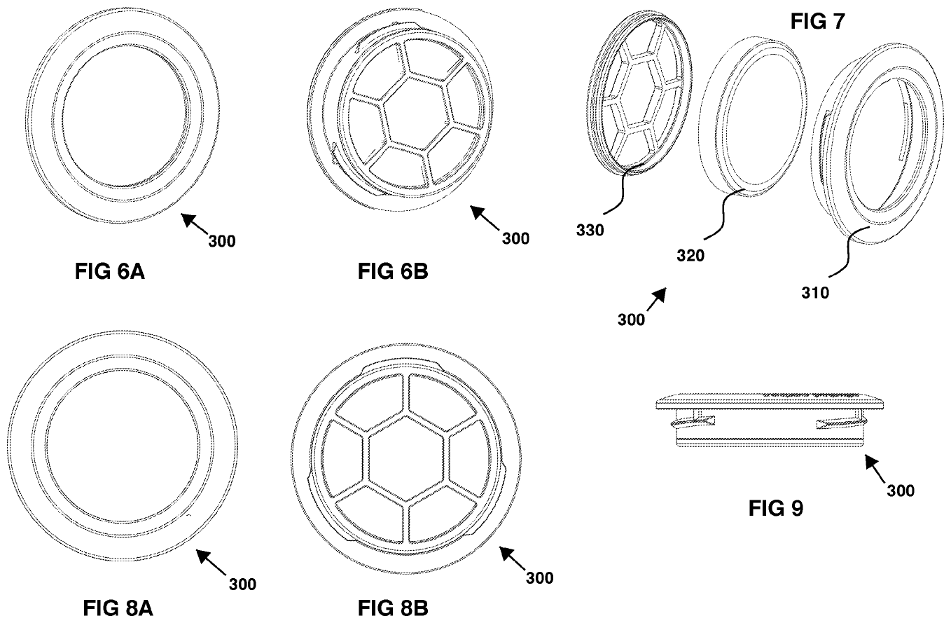

FIG. 6A and FIG. 6B depict the filter assembly 300 in isolation from the greater assembly 1000, with FIG. 7 depicting an exploded view and FIG. 8A and FIG. 8B depicting front and rear views, and FIG. 9 a side view.

Filter assembly 300 comprises filter ring 310, filter cover 320 and filter retainer 330. The filter ring 310 is in assembly outward-facing and the two filter assemblies 300 act in concert to provide secure positioning of the mask cover 100 on the facepiece 500.

The filter ring 310 retains the mask cover 100 in place owing to the peripheral flange 312 that extends laterally and urges the mask cover 100 against the facepiece 500. The ring body 314 of the filter ring 310 carries screw thread portions 316 for co-operative and removable engagement with the mask stiffener 600.

The filter cover 320 carries an active carbon filter cartridge (not shown), and also provides a protective exterior screening for the inserted filter cartridge.

Components of the filter assembly 300 are configured and dimensioned to accept commercially available activated carbon filter cartridges.

The filter retainer 330 is removably fitted to the filter ring 310, and acts to hold the filter cartridge in place while also permitting passing of incoming filtered air.

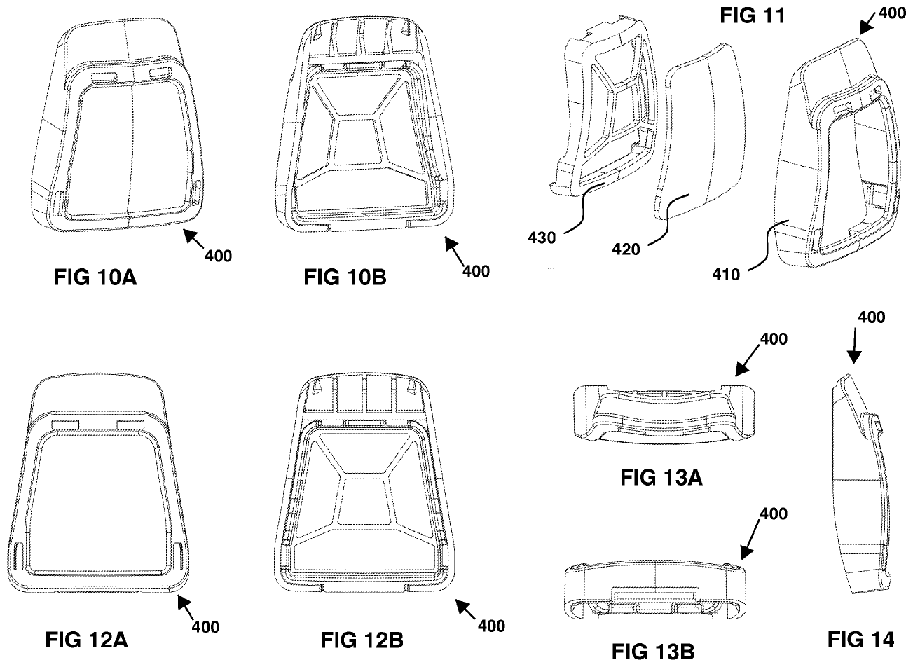

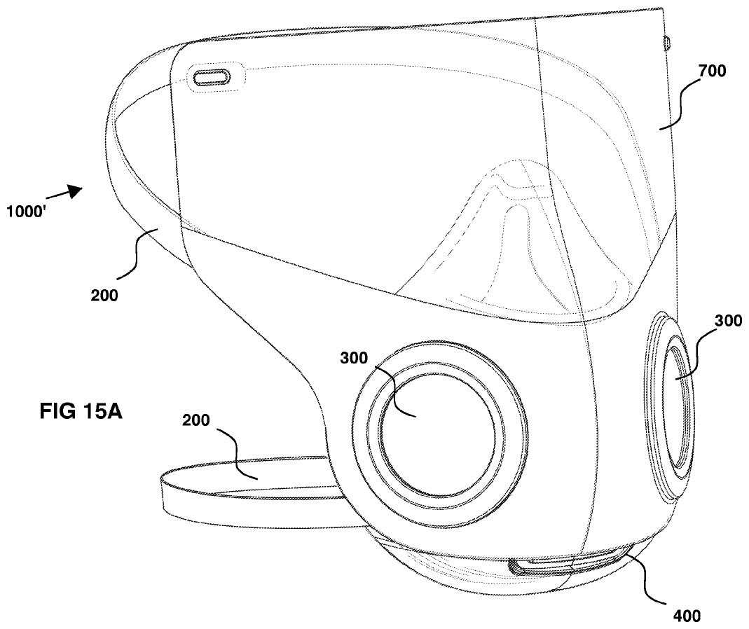

FIG. 10A and FIG. 10B depict the exhaust assembly 400, comprising exhaust cover 410, exhaust seal 420, and exhaust seal retainer 430. FIG. 11 depicts an exploded view of these components 410, 420, 430. As a matter of completeness, FIG. 12A and FIG. 12B depict front and rear views, FIG. 13A and FIG. 13B depict top and bottom views (that is, in plan), and FIG. 14 depicts a side view (that is, in elevation).

The exhaust assembly 400 acts as a one-way valve passing exhausted breath out of the facepiece 500 in use, but not admitting air into the facepiece 500 in use. As will be appreciated, the exhaust assembly 400 can be arranged in various configurations to achieve this objective.

The exhaust cover 410 provides structure to the exhaust assembly 400 and retains the exhaust seal 420. The exhaust seal 420 features a bracket 422 that clamps an upper edge of the seal 420 when the exhaust seal retainer 430 is removably fitted to the exhaust cover 410.

In use, when the wearer exhales, the exhaust seal 420 displaces along its lower edge to permit exhaust of the exhaled air from the facepiece 500. This specific arrangement has a benefit of the exhaled breath exhausting below the mask cover 100. The mask cover 100 hides the exhaust assembly 400 (in large degree), providing a cleaner visual appearance to the assembly 1000.

FIG. 15A and FIG. 15B depict an assembly 1000′ similar in most respects to the assembly 1000 described above and depicted in connection with FIG. 1A and FIG. 1B, and drawings through to FIG. 14, though alternatively configured to feature a face shield 700 as a substitute for mask cover 100. This alternative configuration is denoted as respiratory mask assembly 1000′ to distinguish from the assembly 1000 featuring mask cover 200.

As will be appreciated, alternative embodiments are possible in which the face shield 700 can be featured as an addition to rather than as a substitute for mask cover 100.

The face shield 700 is removably fitted to the facepiece 500 in the same manner as mask cover 100 is removably fitted to the facepiece 500, and foregoing description applies save where context indicates otherwise.

The face shield 700 is generally laminar, and shaped as depicted with openings dimensioned to accommodate the filter assemblies 300 which when assembled pass through the face shield 700 (in common with mask cover 100).

The face shield 700 is transparent, at least in part if not in its entirety. The face shield 700 comprises an upper portion 720 that is transparent, and a lower portion 710 that may be printed for similar reasons as described in connection with the mask cover 100. When fitted and worn, the (optionally printed) lower portion 710 of the face shield 700 overlays the oral region surrounding the mouth of the wearer, and extends over parts of the buccal and paratid regions towards the auricular regions surrounding the ears of the wearer.

As depicted, the face shield 700 extends upwardly to and beyond the orbital region (around the eyes) of the wearer to terminate at its upper extent at a lower part of the frontal region of the wearer (the forehead). The transparent upper portion 720 of the face shield 700 overlays the orbital regions surrounding the eyes, the nasal region surrounding the nose, as well as parts of the infra-orbital regions below the eyes and a lower portion of the frontal region above the eyes. As described above, the nasal region is also overlayed by the transparent facepiece 500 of the respiratory mask assembly 1000′.

The face shield 700 when fitted and worn provides a protective barrier to the eyes. The barrier is not sealed, as it is open along upper and lateral edges, with a minimal clearance.

The face shield 700 is spaced apart from the face in use. Spacers 730 are fitted at both upper corners of the face shield 700, in the form of bungs insertable and removable from matched openings positioned at both corners. Other configurations of spacers 730 are possible, and may be omitted in alternative embodiments. The spacers 730 may contact the wearer's face upwardly and outwardly of the orbital regions at the frontal region, when the respiratory mask assembly 1000′ is fitted and worn correctly, to provide a comfortable fit to the wearer.

The foregoing description concerns a preferred embodiment only. As will be appreciated many modifications or alternatives may be made without departing from the present invention.

1. A respiratory mask assembly comprising a facepiece sealable in use against a wearer's face, a mask stiffener removably fitted to an inwardly-facing side of the facepiece, an interchangeable mask cover removably fitted to an outwardly-facing surface of the facepiece and removably attachable to the mask stiffener, at least one filter assembly forming an inhalation port through the assembled mask cover, the facepiece and the mask stiffener member, and an exhaust assembly forming an exhalation port through the facepiece.

2. A respiratory mask assembly comprising a facepiece sealable in use against a wearer's face, a mask stiffener removably fitted to an inwardly-facing surface of the facepiece, a mask cover or face shield removably fitted to an outwardly-facing surface of the facepiece and removably attachable to the mask stiffener, at least one filter assembly forming an inhalation port through the assembled mask cover or face shield, facepiece and mask stiffener, and an exhaust assembly forming an exhalation port through the facepiece, wherein the facepiece is transparent.

3. A respiratory mask assembly comprising a facepiece sealable in use against a wearer's face, a mask stiffener removably fitted to an inwardly-facing surface of the facepiece, an interchangeable face shield removably fitted to an outwardly-facing surface of the facepiece and removably attachable to the mask stiffener, at least one filter assembly forming an inhalation port through the assembled face shield, facepiece and mask stiffener, and an exhaust assembly forming an exhalation port through the facepiece.

4. A respiratory mask assembly comprising a facepiece sealable in use against a wearer's face, a mask stiffener removably fitted to an inwardly-facing surface of the facepiece, a mask cover or face shield removably fitted to an outwardly-facing surface of the facepiece and removably attachable to the mask stiffener, at least one filter assembly forming an inhalation port through the assembled mask cover or face shield, the facepiece and the mask stiffener, and an exhaust assembly forming an exhalation port through the facepiece, wherein the mask cover or face shield is positioned to occlude the exhaust assembly from view.

5. A respiratory mask assembly of any one of claims 1 to 4, wherein two spaced apart filter assembles are provided, one on each of opposed lateral sides of the entire assembly to locate and clamp together the mask cover or face shield, the facepiece and the mask stiffener.
